(19) United States
(12) Patent Application Publication
(10) Pub. No.: US 2006/0244240 A1
(43) Pub. Date: Nov. 2, 2006

(54) Towing pintle assembly

(75) Inventor: Richard Ian Nelson, Shepshed, Leicestershire (GB)

Correspondence Address: CROWELL & MORING LLP;INTELLECTUAL PROPERTY GROUP, P.O. BOX 14300, WASHINGTON, DC, 20044-4300, US

(73) Assignee: BAE SYSTEMS PLC, LONDON (GB)

(21) Appl. No.: 10/522,630

(22) PCT Filed: Dec. 9, 2004
(86) PCT No.: PCT/GB04/05174

§ 371 Date: Jan. 31, 2005

(51) Int. Cl. B60D 1/06

(52) U.S. Cl. 280/512

(57) ABSTRACT

A towing pintle assembly 10 comprises a main body portion 18 attached by a flange 14 to the vehicle body. A hook 24 is pivotally coupled at its mid region to the main body by a pivot 22. To the upper end of the hook 24 is pivotally connected a locking lever 32. The locking lever may be swung between a locking position in which locking surfaces 34 thereon abut an abutment 36 to prevent opening of the hook and a free position in which the hook may open. The locking lever 32 may be moved to the free position either manually, or remotely by fluid-operated pistons 44. A frangible sheer pin 46 holds the locking lever in the locking position.

This invention relates to towing pintle assemblies intended in use to be connected to a towing vehicle and to co-operate with a towing eye associated with a towed vehicle by a draw bar or the like.

Towing pintles are a common form of towing hitch in both civil and military applications. Conventionally, the main part of the towing pintle is a hook or horn over which the towing eye passes with there being some form of latch which closes against the hook or horn to prevent inadvertent removal of the eye during use. There are a variety of safety mechanisms to ensure that the latch does not open inadvertently. Such latches however require the operator to get out of the towing vehicle and to release the latch manually. There are however situations both in civil and military applications where there is a need to be able to release the towed vehicle remotely. In civil applications it is time-consuming to require the vehicle driver to get out of the cab and in military applications there are often instances where it may be required to release a towed vehicle ‘under armour’ that is again without requiring the driver of the towing vehicle to leave the protection afforded by the vehicle. This may be for reasons of safety or speed. It is known to provide a towing pintle assembly which includes an explosive bolt which can be remotely released to open the assembly rapidly. There is a need however for a towing pintle assembly which is rapidly releasable but which does not involve the use of an explosive bolt.

Accordingly, in one aspect, this invention provides a towing pintle assembly comprising:

a first jaw member for attachment in use to a towing vehicle;

a second jaw member movably mounted on said first member for movement between a closed position, in which said first and second jaw members co-operate for retaining in use a towing eye of a towed vehicle, and an open position, in which in use a towing eye may be withdrawn from or introduced between said jaw members;

a locking member pivotally mounted on said second jaw member and arranged such that, when said second jaw member is in its closed position, said locking member may be moved between a locked position, in which a locking surface on said locking member faces a relatively fixed abutment surface, such that movement of said second jaw member towards its open position is prevented by said locking surface abutting said abutment surface, and a release position, in which said second member may be pivoted to the open position, and

fluid-operated means for urging said locking member from said locking position to said release position, to allow said second jaw member to be moved to its open position.

Although there are many different possible configurations, in one embodiment said first jaw member is relatively fixed and includes means for attachment, in use, to the towed vehicle.

In this embodiment, said second jaw member may be of hooked form and directed downwardly thereby in use to pass through a towing eye to carry a major part of the drag load from the towed vehicle.

Preferably, said second jaw member is pivotally mounted on said first jaw member, and said locking member is pivotally mounted on said second jaw member, by respective generally parallel and horizontal respective pivots.

Preferably said locking member may also be moved between said locked and release positions by hand. The assembly preferably includes releasable retention means arranged to retain said locking member in said locked position. The retention means may comprise a locking pin.

Said fluid-operated means preferably comprises at least one fluid-operated ram, and more preferably two fluid-operated rams in spaced parallel relationship and adapted to co-operate with spaced regions on said locking member, the fluid-operated rams being connected to a common fluid passage.

In particular applications said first jaw member may be mounted on attachment means for movement in use about a rotary axis relative to the towing vehicle, and there may be rotary lock means for locking said first jaw member against rotational movement.

Whilst the invention has been described above it extends to any inventive combination of features described above or in the following description.

The invention may be performed in various ways, and two embodiments thereof will now be described by way of example only, reference being made to the accompanying drawings, in which:

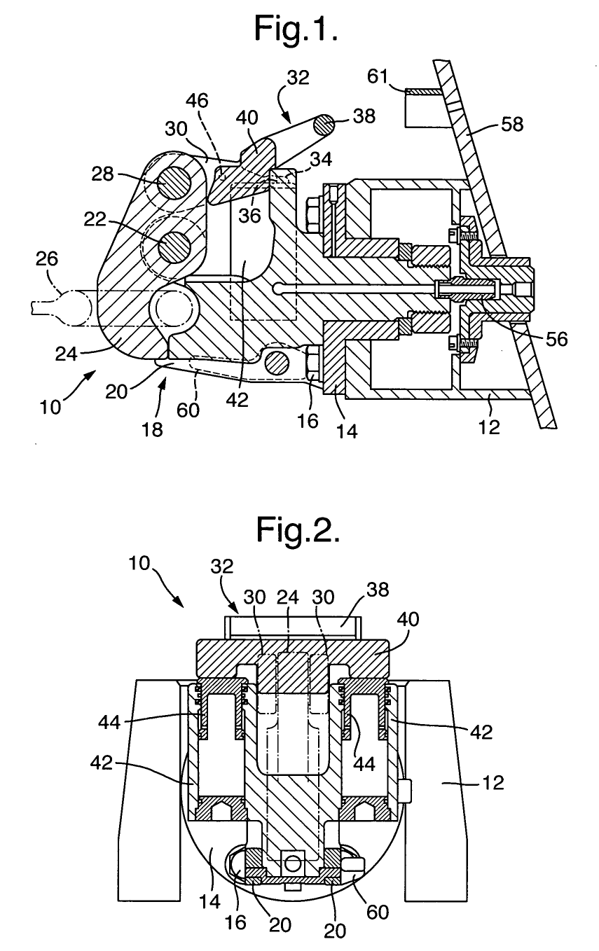

FIG. 1 is a cross-section side view through a first embodiment of towing pintle assembly in accordance with this invention, with the hook in the closed and locked position;

FIG. 2 is a rear view, taken on lines II-II on the arrangement of FIG. 1;

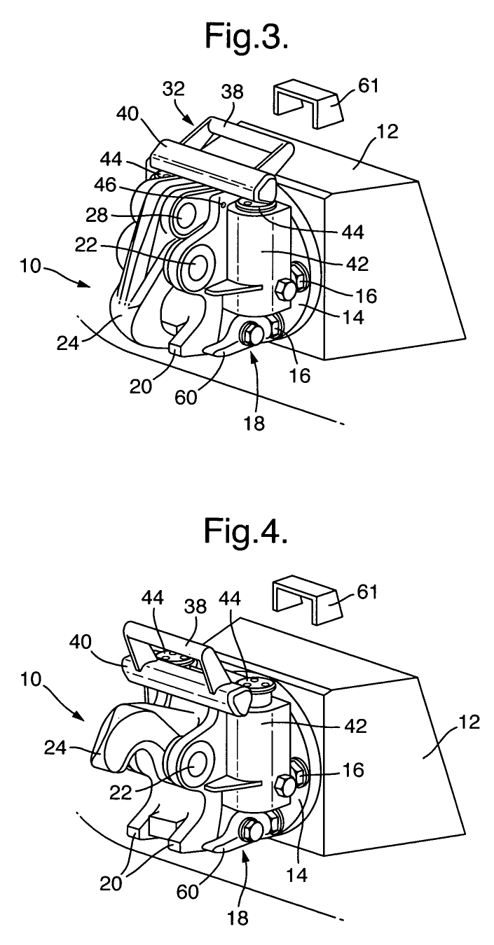

FIG. 3 is a general perspective view of the embodiment of FIG. 1 with the hook in the closed and locked position;

FIG. 4 is a general perspective view of the embodiment of FIG. 1 with the hook in an open position;

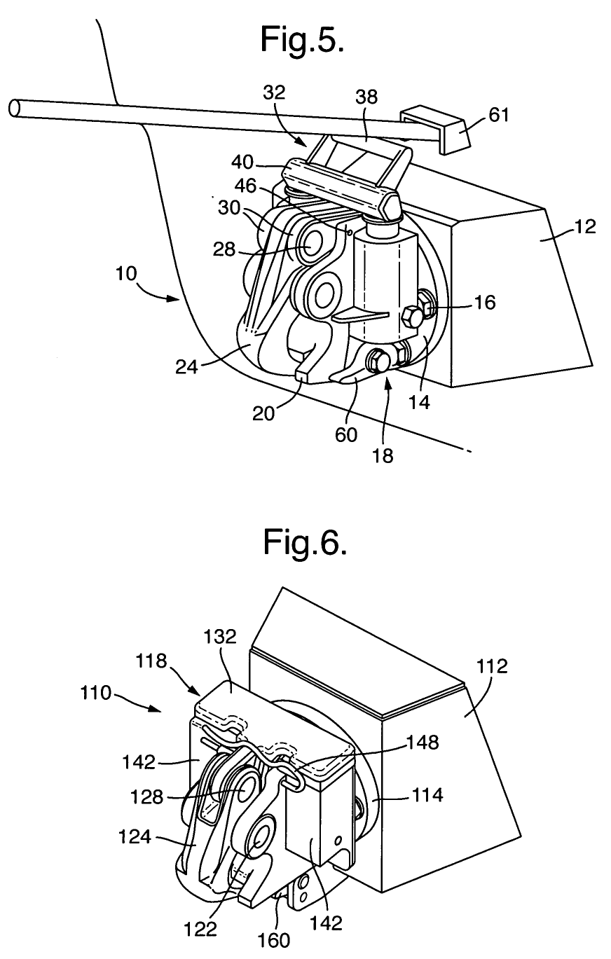

FIG. 5 is a general perspective view of the embodiment of FIGS. 1-4, showing how the towing pintle is re-set after remote hydraulic actuation;

FIG. 6 is a general perspective view of a second embodiment of towing pintle assembly with the hook in the closed and locked position;

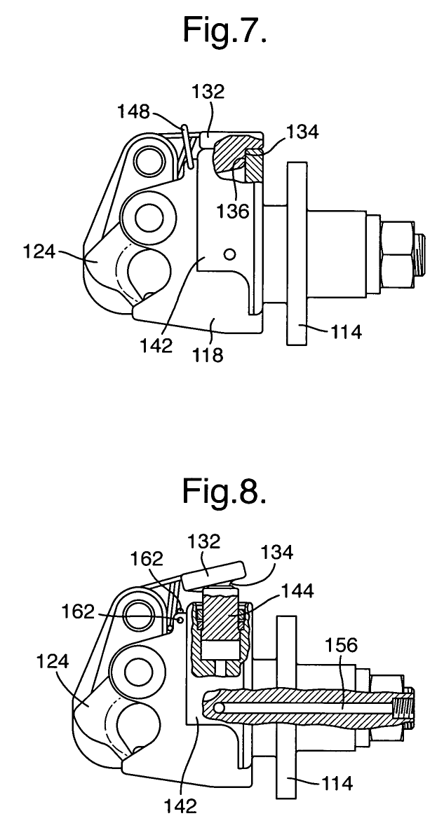

FIG. 7 is a side view, in part section, of the second embodiment with the hook in the closed and locked position;

FIG. 8 is a side view, in part section, of the second embodiment showing the locking member released;

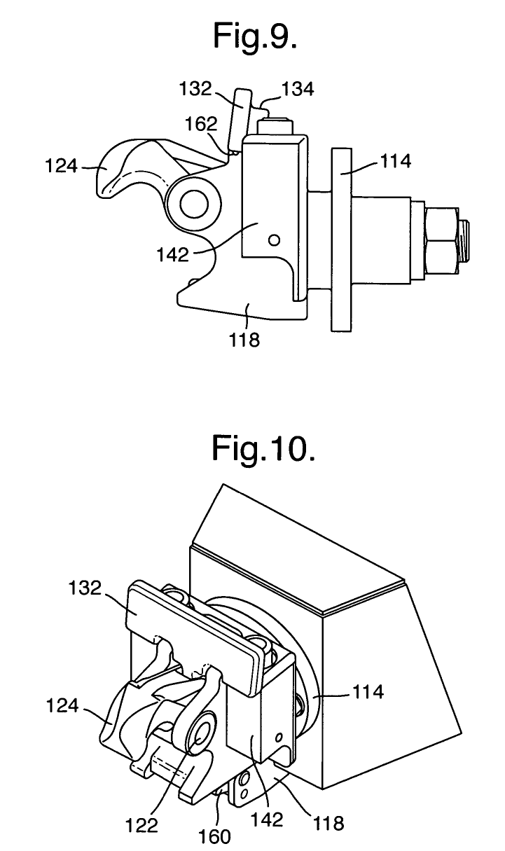

FIG. 9 is a side view, of the second embodiment showing the locking member released and the hook open, and

FIG. 10 is a general perspective view of the second embodiment with the locking member released and the hook open.

The embodiments of towing pintle assembly described and illustrated herein are intended for use on the rear of a towing vehicle and to allow release either manually or, where circumstances demand, by remote actuation. Remote actuation may be required for example for speed, or where the external environment is hazardous, or where the towed vehicle might compromise the stability or the progress of the towing vehicle.

Referring initially to the first embodiment of FIGS. 1-5, the pintle assembly 10 is shown attached to a fabricated mount 12 secured to a towing vehicle (not shown). The pintle assembly comprises a mounting flange 14 secured to the fabricated mounting 12 by means of bolts 16. The flange 14 rotatably supports a main body portion 18 which comprises respective side brackets 20 which are spaced and parallel and support a pivot 22 which pivotally couples a hook 24 to the main body portion 18. The forward, lower surface of the hook co-operates with the facing surface of the main body portion 18 below the side brackets 20 to act as a jaw arrangement moveable between the closed position shown in FIGS. 1 and 3 in which a towing eye 26 (shown in dotted lines in FIG. 1) is prevented from escaping from the jaw, and the open position shown in FIG. 4 in which the towing eye is released.

The upper end of the hook 24 carries a pivot 28 which pivotally carries the side arms 30 of a locking lever 32. The side arms 30 of the locking lever each include a locking surface 34 which, when the assembly is in the closed and locked position shown in FIGS. 1 and 3, abuts an abutment surface 36 on the main body portion 18 such that the primary towing loads, which in use apply a moment tending to rotate the hook to the open position, are resisted by co-operation of the locking surfaces 34 and the abutment 36.

The locking lever 32 has a manually grippable handle 38 at its end remote from the pivot 28 and, between the two, a drive bar 40. The main body portion also houses a pair of parallel hydraulic cylinders 42 each of which receives a piston 44 and can be driven hydraulically from the retracted position shown in FIGS. 1-3 to the extended position shown in FIGS. 4 and 5. The hydraulic pistons 44 are aligned with opposite ends of the drive bar 40 and, when operated, urge the drive bar to move the locking lever 32 to move the locking surfaces 34 out of engagement with the abutment 36.

During normal locked use, the locking lever is maintained in the locked position by a frangible locking pin 46 which passes through aligned bores in the locking lever 32 and the side brackets 20.

The hydraulic cylinders 42 are connected to a common hydraulic feed passage 56 (see FIG. 1) which terminates in a hydraulic coupling 58 located within the fabrication mounting 12. The hydraulic fluid passage 56 is designed to allow transmission of hydraulic fluid across the rotary interface between the flange 14 and the main body portion 18 in known manner.

A rotary lock comprises a pair of arms 60 pivotally mounted on the main body portion 18 and rotatable between a position shown in FIGS. 1-5 where they co-operate with the main body portion 18 below the side brackets 20 to prevent rotation of the main body portion with respect to the flange 14, and a position in which the arms are swung clear to allow rotation of the main body portion where rotational freedom is required.

During normal operation from the closed position shown in FIGS. 1-3, the towing pintle assembly 10 may be opened by manually removing the pin 46 and swinging the locking lever 32 upwards using the handle 38 so as to swing the locking surfaces 34 out of engagement with the abutment 36. The hook 24 can then be pivoted to an open position about the pivot 22 to allow the hook to pass through and close, jaw-like, around the towing eye 26 (FIG. 1 only). The hook 24 may then be swung closed and the locking lever returned to its locking position with the locking surfaces 34 in abutment with the abutment 36. The pin 46 is then replaced to maintain the locking lever 32 in its locking position.

In a forced opening operation, the driver or operator operates a remote unit which pressurizes the hydraulic fluid in the passage 56, and which causes the hydraulic pistons 44 to extend, which pushes the drive bar 40 upwards to move the locking lever 32 towards its open position. As it does so the pin 46 shears as the locking lever moves away from its locking position.

Referring to FIG. 5, once the pintle assembly has been remotely actuated by extension of the hydraulic cylinders 42, it may be re-set by engaging a lever in a fulcrum bracket 60 attached to the hull of the vehicle a distance above the fabricated mounting 12, and urging the locking lever 32 back to its closed and locked position by engaging the drive bar 40 and pushing the hydraulic pistons 44 back to the retracted positions with the lever 32 and the latch mechanism returning to the closed and locked positions of FIG. 3.

Referring now to the embodiment of FIGS. 6-10, the second embodiment of pintle assembly 110 is of generally similar form to that of the first embodiment. The assembly 110 comprises a flange 114 attached to a fabricated housing 112 on the towing vehicle. Rotatably secured to the flange 114 is a main body portion 118, with there being an anti-rotation lock 160. As previously the main body portion 118 pivotally supports a hook 124 to the upper end of which is pivotally mounted by pivot 128 a locking member 132. As seen particularly in FIG. 7, the locking member 132 has a locking surface 134 which abuts an abutment 136 on the main body portion 118, when the hook is in its closed position and the locking member is in its locking position. In this configuration, the hook 124 is locked in the closed position. The locking member 132 is secured in the locking position by means of a retention shear pin 148 with a ‘p’ clip head, the body of the pin passing through aligned bores 162 in the main body portion 118 and the locking member 132 respectively. The main body portion houses two hydraulic actuators comprising respective hydraulic cylinders 142 and hydraulic pistons 144 operable to urge the locking member 132 from the locked position shown in FIGS. 6 and 7 to the released positions shown in FIGS. 8, 9 and 10. As previously the hydraulic cylinders are fed through a common hydraulic fluid passage 156.

In operation, from the closed position shown in FIG. 6, the assembly may be opened manually by withdrawing the retention shear pin 148, rotating the locking member 132 to swing the locking surface 134 clear of the abutment 136 and then pivoting the hook 124 to an open position. The hook 124 may be returned to a closed and locked position by reversing the above actions.

In order to release the hook remotely, hydraulic pressure is applied through the hydraulic fluid passage 156 to extend the hydraulic pistons 144 to rotate the locking member 132 to move the locking surfaces 134 of the abutment and in doing so, shearing the retention shear pin as shown in FIG. 8. A rearward force, for example from the towing eye, opens the hook 124 to release the towing eye as shown in FIG. 10.

The assembly may be re-set by driving the locking member 132 back to its locked position and in so doing driving the hydraulic pistons 144 to the retracted position, and then replacing the shear pin 148.

1. A towing pintle assembly comprising:
a first jaw member for attachment in use to a towing vehicle;
a second jaw member movably mounted on said first member for movement between a closed position, in which said first and second jaw members co-operate for retaining in use a towing eye of a towed vehicle and an open position in which in use a towing eye may be withdrawn from or introduced between said jaw members;
a locking member pivotally mounted on said second jaw member and arranged such that, when said second jaw member is in its closed position, said locking member may be moved between a locked position in which a locking surface on said locking member faces a relatively fixed abutment surface, such that movement of said second jaw member towards its open position is prevented by said locking surface abutting said abutment surface, and a release position in which said second member may be pivoted to the open position, and
fluid-operated means for urging said locking member from said locking position to said release position, to allow said second jaw member to be moved to its open position.

2. A towing pintle assembly according to claim 1, wherein said first jaw member is relatively fixed and includes means for attachment, in use, to the towed vehicle.

3. A towing pintle assembly according to claim 1, wherein said second jaw member is of hooked form and directed downwardly thereby in use to pass through a towing eye to carry a major part of the drag load from the towed vehicle.

4. A towing pintle assembly according to claim 1, wherein said second jaw member is pivotally mounted on said first jaw member, and said locking member is pivotally mounted on said second jaw member, by respective generally parallel and horizontal respective pivots.

5. A towing pintle assembly according to claim 1, wherein said locking means is manually moveable between said locked and released positions.

6. A towing pintle assembly according to claim 5, wherein said releasable retention means comprises a locking pin.

7. A towing pintle assembly according to claim 1, wherein said fluid-operated means comprise at least one fluid-operated ram.

8. A towing pintle assembly according to claim 7, wherein said fluid-operated means comprises two fluid-operated rams in spaced parallel relationship and adapted to co-operate with spaced regions on said locking member, the fluid-operated rams being connected to a common fluid passage.

9. A towing pintle assembly according to claim 2, wherein, in use, said first jaw member is mounted on said attachment means for movement about a rotary axis.

10. A towing pintle assembly according to claim 9, including rotary lock means for locking said first jaw member against rotational movement.
